(19) United States
(12) Patent Application Publication
(10) Pub. No.: US 2001/0048181 A1
(43) Pub. Date: Dec. 6, 2001

(54) Method and apparatus for producing reinforced thermoplastic composites

(76) Inventors: Suresh Deepchand Shah, Troy, MI (US); Edward Joseph Wenzel, Troy, MI (US); Carl Henry Visconti, Clarkston, MI (US); Jason Alan Waite, Lake Orion, MI (US)

Correspondence Address: KATHRYN A. MARRA, DELPHI TECHNOLOGIES, INC., Legal Staff Mail Code: 480-414-420, P.O. Box 5052, Troy, MI, 48007-5052, US

(21) Appl. No.: 09/767,036

(22) Filed: Jan. 22, 2001

Related U.S. Application Data
(60) Provisional application No. 60/186,820, filed on Mar. 3, 2000.

(51) Int. Cl. B29C 45/00

(52) U.S. Cl. 264/328.8; 264/328.18; 425/130; 425/256; 425/557

(57) ABSTRACT

An apparatus having a single screw extruder and a twin screw extruder. The extruders are designed to operate intermittently in a batch-type process. The single screw extruder contains a plurality of barrel segments with an internal cavity, an inlet and a transfer die located at an outlet. The barrel segments provide processing flexibility in that the L/D ratio of the single screw extruder can be varied to accommodate various materials, fillers and material throughputs. The twin screw extruder includes a body having an internal cavity disposed therein. The body includes an inlet at a first end, an outlet at a second end and an inlet located along the length of the twin screw extruder to accept fiber material (fibers) from a side stuffer. A transfer valve is connected to the outlet of the twin screw extruder. The transfer valve controls the flow of melt from the twin screw extruder into an injection plunger. A polymer material (resin) is fed into the internal cavity of the single screw extruder by a feeding device. The fiber material is fed from a fiber source into the internal cavity of the twin screw extruder through an inlet. The outlet of the twin screw extruder is coupled with transfer valve. An injection plunger releasably docks or couples with the transfer valve. The injection plunger includes an outlet and an internal cavity, and is movably mounted on a positioning unit. The positioning unit allows the injection plunger to be coupled to the transfer valve and also to be uncoupled from the transfer valve, and moved in three dimensions (x, y, z coordinate planes) over a core.

### CROSS REFERENCE TO RELATED APPLICATIONS

This application claims the benefit of United States Provisional Patent Application No. 60/186,820, filed on Mar. 3, 2000, the contents of which are incorporated herein by reference thereto.

### BACKGROUND OF THE INVENTION

Molded thermoplastic materials are widely used. One such application is in vehicular applications where molded pieces are used. A vehicle includes a vehicle occupant compartment which itself includes a variety of interior components. For example, interior trim sheets for vehicle instrument panels and door trim are fabricated using plastic molding processes. For most molding operations, plastics are heated to a liquid or semi-liquid state, and are formed in a mold under pressure to produce thermoplastic polymer structural components. Fiber reinforced thermoplastic polymers are utilized when increased mechanical properties of the component are desired.

Fiber-reinforced thermoplastic polymer structural components are most commonly manufactured from long, fiber thermoplastic (LFT) granulates (pellets), glass mat thermoplastic (GMT) sheets, or pultruded sections. Long, fiber-reinforced granulates typically consist of glass fiber bundles encapsulated with a thermoplastic through a cable coating or a pultrusion process. LFT granulates can be injection-molded, but are more commonly extrusion compression molded in order to preserve fiber length in the finished product. Although the damage to LFT granulates during processing is reduced when extrusion compression molded, some damage can occur during the plastication process due to mechanical shear imparted to the material by the extruder screw and barrel.

GMT sheets consist of a needle-punched glass mat impregnated with a thermoplastic polymer (typically polypropylene) to form a glass-reinforced thermoplastic sheet which is subsequently heated and compressed in a vertical compression press to obtain the final part shape. Desired mechanical properties of parts produced from GMT sheets can be custom tailored via the orientation of the glass fibers within the sheet. Overall mechanical properties are as good and many times improved over parts produced from LFT granulates, particularly in the area of impact strength. However, GMT sheets require preheating prior to compression molding and have flow limitations in the direction perpendicular to a die draw.

Polymer components reinforced with fibers may also be manufactured using continuous in-line extrusion methods known in the art. One such method involves the plastication of a polymer in a first single screw extruder from which the output is fed to a second single screw extruder. Fibers are introduced in the polymer melt in the second extruder in chopped-segmented form and compounded with the polymer melt. The fiber-reinforced polymer compound is fed into an accumulator prior to robotic or manual transfer to a compression molding tool, wherein the fiber-reinforced polymer compound is shaped as required for a particular application. Alternatively, the fiber-reinforced polymer compound may be continuously extruded onto a conveyor and sectioned thereupon. The conveyor delivers the sectioned fiber-reinforced polymer compound to a placement assembly which removes the sectioned compound from the conveyor and places the compound upon the compression molding tool. Continuous compounding using two single screw extruders is limited to chopped or short fibers due to the limited mixing capabilities of the single screw extruder as opposed to the twin screw extruder.

In an alternative method, in-line compounding may employ a solitary twin screw extruder that runs continuously. The twin screw extruder output is fed to a conveyor which partitions the extrudate into shot sizes that are conveyed, either robotically or manually, to a compression mold located within a vertical molding press. Once the melt compound is placed upon the mold cavity, the press closes, compressing the melt compound to fill the mold cavity. Precision of the melt positioning upon the mold cavity using this method is limited to operator ability in the case of manual load of the melt compound or needle gripper articulation in the case of robotic load of the melt compound.

If a vehicle component requires variations in its physical characteristics, then multiple processes are used to produce multiple components. The multiple components are then bonded together to form the final product. For example, a vehicle door panel may require high load bearing characteristics in one location, requiring a long glass fiber reinforced material. However, in another section of the same door panel, structural properties at the same high level may not be required. In this instance, fibers or other fillers are utilized. Alternatively, the entire door panel can be generally molded using the material required to the most stringent of performance requirements for that particular panel. Thus, the door panel has structural properties at the same high level throughout, including sections where such high strength properties may not be required.

### SUMMARY OF THE INVENTION

An apparatus that produces custom compounded thermoplastic composites.

The apparatus of the first embodiment advantageously employs a first extruder, a plunger, and a mold for operating in a batch process for providing a reinforced structure. The first extruder is configured to receive a first meltable material to form a melt compound. A plunger is configured and dimensioned to receive the melt compound. A mold for receiving the melt compound and producing the reinforced structure wherein the melt compound is intermittently released through the injection plunger.

The present invention also describes a method for in-line compounding and extrusion deposit compression molding in a batch process. The method comprises feeding a first material (first meltable material) to a first extruder, melting the first material to provide a melt, extruding the melt within the first extruder, compounding the melt with a fiber material in the first extruder, depositing the melt into a plunger, intermittently stopping the first extruder in a batch process, depositing the melt from the injection plunger into a molding device, and forming the first fiber-reinforced structure within the molding device.

The apparatus provides the flexibility for in-line compounding as well as precompounded material processing combined with EDCM within the same mold cavity, to produce an engineered component that meets the specific component performance requirements. This enhanced flexibility provides for capital cost reductions since the same apparatus may be used for a variety of material processing. Material cost savings are also achieved though the capability of in-line compounding of thermoplastic materials. Operating the apparatus in a batch-type process through the intermittent operation of the first extruder permits the elimination of a static accumulating device to collect the compounded material upon exiting the first extruder.

The above and other objects and advantages of the invention will be apparent from the following description, the accompanying drawings, and the appended claims.

### BRIEF DESCRIPTION OF THE DRAWINGS

The present invention will now be described, by way of example only, with reference to the accompanying drawings in which:

FIG. 1 is a top view of an in-line compounding and extrusion deposit compression molding apparatus according to a first embodiment of the present invention;

FIG. 2 is a top view of an in-line compounding and extrusion deposit compression molding apparatus according to a second embodiment of the present invention;

FIG. 3 is a top view of an in-line compounding and extrusion deposit compression molding apparatus according to a third embodiment of the present invention; and

FIG. 4 is a top view of an in-line compounding and injection molding apparatus according to an alternative embodiment of the present invention.

### DETAILED DESCRIPTION OF THE PREFERRED EMBODIMENT

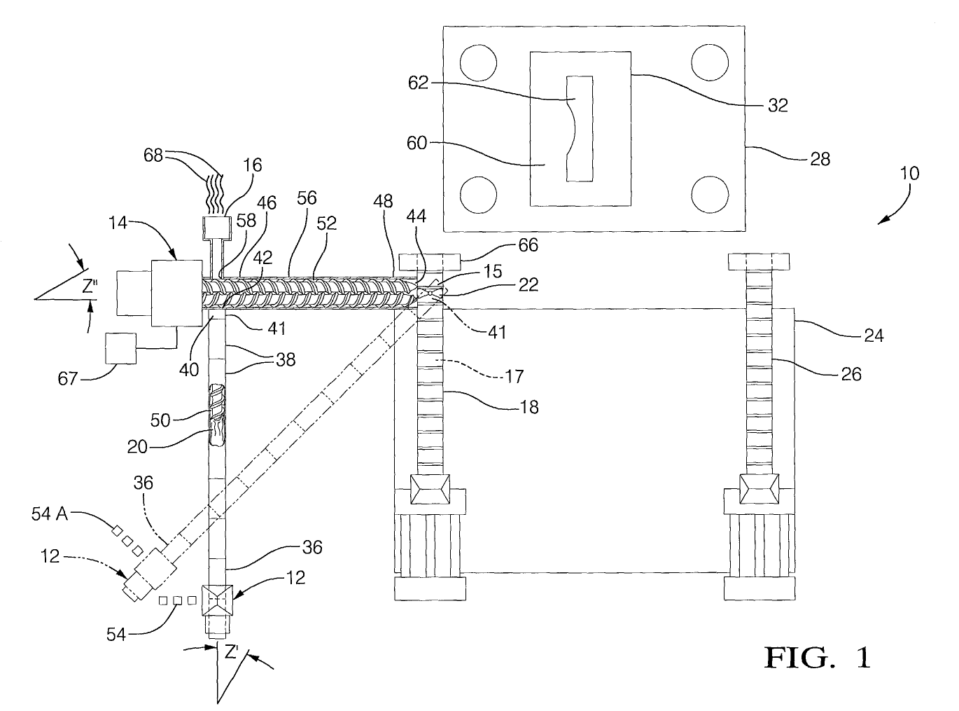

Referring to FIG. 1, an apparatus 10 for producing reinforced thermoplastic is shown.

In an exemplary embodiment, apparatus 10 is used for in-line compounding and extrusion deposit compression molding (EDCM). Apparatus 10 includes a positioning unit, preferably a three-axis table 24 and a single screw extruder, generally shown at 12, a twin screw extruder, generally shown at 14, a side stuffer 16, injection plunger 18, a transfer valve 22 and a press, preferably a vertical compression press 28. The press 28 contains a mold 32 having a female cavity (not shown) and a male core 62, each including a contact surface 60. The male core 62 is complimentary in shape with the female cavity, and mates to the female cavity. The press 28 may be a conventional press generally used for molding polymers into desired shapes and forms.

In an exemplary embodiment of the present invention, the single screw extruder 12 and the twin screw extruder 14 are designed to operate intermittently in a batch-type process. Single screw extruder 12 contains a plurality of barrel segments 38 with an internal cavity 50, an inlet 36 and a transfer die 40 located at an outlet 41. The barrel segments 38 provide processing flexibility in that the L/D ratio of the single screw extruder 12 can be varied to accommodate various materials, fillers and material throughputs. Twin screw extruder 14 includes a body 56 having an internal cavity 52 disposed therein. The body 56 includes an inlet 42 at a first end 46, an outlet 44 at a second end 48, and an inlet 58 located along the length of the twin screw extruder 14 to accept fiber material (fibers) 68 from the side stuffer 16. The transfer valve 22 is connected to the outlet 44 of the twin screw extruder 14. In this way, the transfer valve 22 controls the flow of melt from the twin screw extruder 14 into the injection plunger 18.

A polymer material (resin) 54 is fed into the internal cavity 50 of the single screw extruder 12 by any number of feeding devices including, but not limited to, the use of a hopper (not shown). Often, the polymer material 54 is in the form of plastic pellets.

Fiber material 68 is fed from a fiber source (not shown) into the internal cavity 52 of the twin screw extruder 14 through inlet 58. The fiber material fed into the internal cavity 52 can be achieved by the side stuffer 16, as shown, or other similar feeding devices including, but not limited to, a direct roving feed roller (not shown). A direct roving feed roller (not shown) may be used to feed at least one continuous strand of fiber into the internal cavity 52 of the twin screw extruder 14. Also, the fiber material 68 may be a single reinforcing fiber or a plurality of reinforcing fibers. In a first embodiment of the present invention, side stuffer 16 is in fluid communication with the inlet 58 and is utilized along the length of the twin screw extruder 14 for supplying chopped fibers, such as glass, carbon, cellulosic, or other low bulk density fillers into the internal cavity 52.

The outlet 44 of the twin screw extruder 14 is coupled with transfer valve 22. The injection plunger 18 releasably docks or couples with the transfer valve 22. The injection plunger 18 includes an outlet 15 and an internal cavity 17, and is movably mounted on the positioning unit 24. The positioning unit 24 allows the injection plunger 18 to be coupled to the transfer valve 22, and also to be uncoupled from the transfer valve 22, and moved in three dimensions (x, y, z coordinate planes) over the male core 62.

A method of producing a thermoplastic composite by combining in-line compounding and EDCM using apparatus 10 will now be described. It is noted that in order for the twin screw extruder 14 to operate intermittently, the twin screw extruder 14 must be partially intermeshing and be powered by a hydraulic electric drive unit 67. Screws that are partially intermeshing have flights that overlap or bypass one another along the length of the barrel.

Resin 54 is fed into the single screw extruder 12 through inlet 36. The resin 54 is melted within the plurality of barrels 38, forming a stream of plasticated resin (polymer melt) 20. Upon exiting the transfer die 40, the polymer melt drops vertically downward into an inlet 42 of the twin screw extruder 14. The flow of the polymer melt 20 exiting single screw extruder 12 is controlled by the revolutions per minute (rpm) of the single screw extruder 12. Simultaneously with the operation of the single screw extruder 12, fiber material 68, preferably continuous fiber material drawn from continuous roving creels, enters the internal cavity 52 of the twin screw extruder 14 through the inlet 42. The fiber material 68 is mixed with the polymer melt 20 by the rotational operation of the twin screw extruder 14 to form a compounded fiber reinforced polymer melt (compounded melt, melt compound) within the internal cavity 52. It is noted that the twin screw extruder 14 is starve fed with the fibers and polymer melt 20 in order that variation of the rpm of the twin screw extruder 14 will affect the degree of mixing of the fiber material 68 with the polymer melt 20, as opposed to affecting the output of the twin screw extruder 14.

The compounded melt flows through the twin screw extruder 14 and through the transfer valve 22, which is in the “open” position, and is extruded into the injection plunger 18. In this way, the transfer valve 22 controls the supply of compounded melt exiting the outlet 44 of the twin screw extruder 14 and extruding into the injection plunger 18.

Once the injection plunger 18 reaches a predetermined volume level, preferably via a linear transducer used to measure the position of the plunger piston, rotation of the single and twin screw extruders 12, 14 is stopped, and the transfer valve 22 closes. Once the transfer valve is in the “closed” position, the injection plunger 18 undocks from the valve 22 and selectively deposits, by operator command or automatically by computer or robotic command, the compounded melt onto the male core 62 of mold 32 in a precise and controlled fashion through an outlet die 66. The compounded melt deposited onto the male core 62 is then compressed and cooled with the mold 32. After the component is cooled in the mold 32, the press 28 is opened, and the component demolded.

The positioning unit 24 provides the required capability to maneuver the injection plunger 18 in the x-y-z directions, thus permitting enhanced flexibility of the placement of the compounded melt over the male core 62.

After melt deposition is complete, the injection plunger 18 retracts from the press 28. During the melt compression and cooling, the injection plunger 18 is recoupled with the valve 22. The end of the first process cycle, as described hereinabove, is coordinated with the beginning of the second process cycle.

The second batch of compounded melt is then ready to be formed. The feed of the polymer material 54 and fiber material 68 into the respective inlets 36, 42 of the single and twin screw extruders 12, 14 is coordinated with the required output of compounded melt from outlet 44 of the twin screw extruder 14. The valve 22 shifts to the “open” position to permit flow of compounded melt from the outlet of the twin screw extruder 14 into the injection plunger 18. The rotational operation of the single screw extruder 12 and the twin screw extruder 14 start, and the compounded melt, as described herein above, flows from the outlet 44 of the twin screw extruder 14 through the valve 22 to begin filling the injection plunger 18.

If in-line compounding is not required for part production, apparatus 10 may be used for precompounded material processing. For precompounded material processing, the twin screw extruder 14 is removed. The transfer die 40 is removed from the single screw extruder 12 (shown in phantom) and the transfer valve 22 is connected to the outlet 41 of the single screw extruder 12. The single screw extruder 12 (shown in phantom) is coupled directly to the injection plunger 18 via the transfer valve 22, and directly feeds the compounded melt to the internal cavity 17 of the injection plunger 18.

The method of using apparatus 10 with precompounded material will now be described, where like reference numbers refer to like parts.

A precompounded polymer material 54A is fed into the single screw extruder 12 (shown in phantom) through inlet 36 by any number of feeding devices including, but not limited to, the use of a hopper (not shown). Often, the precompounded polymer material 54A is in the form of plastic precompounded pellets. The polymer material 54A is melted within the plurality of barrel segments 38 forming a precompounded polymer melt. Upon exiting the outlet 41, the precompounded polymer melt is fed into the injection plunger 18 via the valve 22. In this way, the transfer valve 22 controls the supply of precompounded polymer melt exiting the outlet 41 of the single screw extruder 12 and extruding into the injection plunger 18.

Once the volume of precompounded polymer melt reaches a predetermined level in the injection plunger 18, rotation of the single screw extruder 12 is stopped, and the valve 22 closes. The injection plunger 18 separates from the valve 22 and selectively deposits, by operator command or automatically by computer or robotic command, the precompounded polymer melt onto the male core 62 of the mold 32 in a precise and controlled fashion through outlet die 66. The precompounded polymer melt deposited onto the male core 62 is then compressed and cooled by the mold 32 within the press 28. After the component is cooled, the press 28 is opened and the component demolded. The positioning unit 24 provides the required capability to maneuver the injection plunger 18 in the x-y-z direction, thus permitting enhanced flexibility of the placement of the precompounded polymer melt onto the male core 62 of the mold 32.

After melt deposition is complete, the injection plunger 18 retracts from the press 28 and is recoupled with the valve 22.

The second batch of precompounded polymer melt is then ready to be formed. The precompounded pellets 54A are fed into the inlet 36 of the single screw extruder 12 for plasticating within the internal cavity 50 of the single screw extruder 12. The valve 22 shifts to the “open” position to permit flow of precompounded polymer melt from the outlet of the single screw extruder 12 into the injection plunger 18. The rotational operation of the single screw extruder 12 starts, and the precompounded polymer melt flows from the outlet 41 of the single screw extruder 12, through the valve 22, to begin filling the injection plunger 18. The extrusion of compounded melt into the injection plunger 18 is completed immediately prior to the time the injection plunger 18 undocks from the melt transfer valve 22 for the next cycle.

For the first embodiment shown in FIG. 1 for in-line compounding and EDCM, the single screw extruder 12 and the twin screw extruder 14 are shown positioned generally perpendicular to each other. In this configuration, as illustrated in FIG. 1, short screw (not shown) is installed within the internal cavity 50 of the single screw extruder 12. It is understood by those skilled in the art that alternatively, the single screw extruder 12 may be moved rearward, as opposed to removing the barrel or screw segments to shorten the existing configuration. Furthermore, the position between the single screw extruder 12 and the twin screw extruder 14 may vary depending on floor space constraints. For example, the single screw extruder 12 may be rotated an angle z′ degrees about the z axis (shown in FIG. 1), and the twin screw extruder 14 may be rotated at an angle z″ degrees about the z axis in order to avoid barrel and screw segment removal within the single screw extruder 12. It may also be desirable to position the single and twin screw extruders 12, 14, respectively, such that the single screw extruder 12 is in line with the twin screw extruder 14 in order to save available floor space on which to mount apparatus 10.

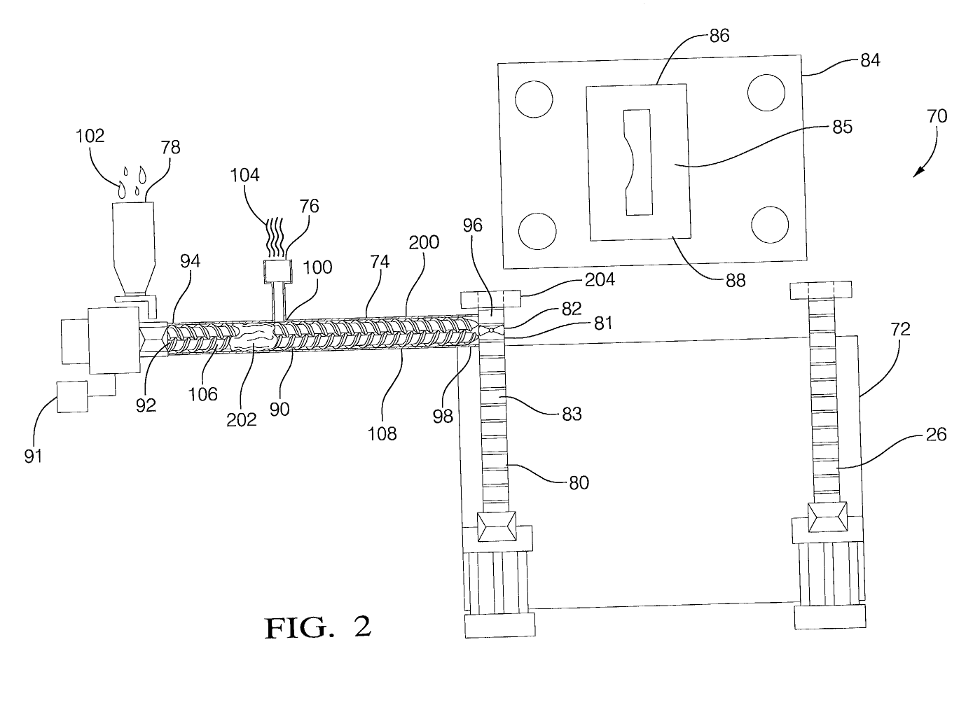

Referring to FIG. 2, an apparatus 70 for producing thermoplastic composites using in-line compounding and extrusion deposit compression molding (EDCM) according to a second embodiment of the present invention is shown.

The apparatus 70 includes a positioning unit, preferably a three-axis table 72 and a solitary twin screw extruder, generally shown at 74, a side stuffer 76, a gravimetric dosing unit 78, an injection plunger 80, a transfer valve 82 and a press, preferably a vertical compression press 84. The press 28 contains a mold 86 having a female cavity (not shown) and a male core 88, each including a contact surface 85. The male core 88 is complimentary in shape with the female cavity and mates to the female cavity. The press 84 may be a conventional press generally used for molding polymers into desired shapes and forms.

The twin screw extruder 74 is designed to operate intermittently in a batch-type process. Twin screw extruder 74 includes a body 200 having an internal cavity 90 disposed therein. The body 200 includes an internal cavity 90 having an inlet 92 at a first end 94, an outlet 96 at a second end 98, and an inlet 100 located along the length of the twin screw extruder 74 to accept fiber material (fibers) 104 from the side stuffer 76. The transfer valve 82 is connected to the outlet 96 of the twin screw extruder 74. In this way, the transfer valve 82 controls the flow of melt from the twin screw extruder 74 into the injection plunger 80.

A polymer material (resin) 102 is fed into the twin screw extruder 74 through inlet 92 by any number of feeding devices including, but not limited to, the use of the gravimetric dosing unit. Often, the polymer material 102 is in the form of plastic precompounded pellets. The polymer material 102 is melted within the twin screw extruder 74.

Fiber material 104 is fed from a fiber source (not shown) into the internal cavity 90 of the twin screw extruder 74 through a side stuffer 76 located along the length of the twin screw extruder 74. The fiber material 104 fed into the internal cavity 90 can be achieved by the side stuffer 76, as shown, or other similar feeding devices including, but not limited to, a reel, a direct roving feed roller. A direct roving feed roller may be used to feed at least one continuous strand of fiber into the internal cavity 90 of the twin screw extruder 74. Also, the fiber material 104 may be a single reinforcing fiber or a plurality of reinforcing fibers. The side stuffer 76 is in fluid communication with the internal cavity 90. The side stuffer is utilized along the length of the twin screw extruder 74 for supplying chopped glass fibers or other low bulk density fillers into the internal cavity 90.

The outlet 96 of the twin screw extruder 74 includes transfer valve 82. The injection plunger 80 releasably docks or couples with the transfer valve 82. The injection plunger 80 includes an inlet 81 and an internal cavity 83 and is movably mounted on the positioning unit 72. The positioning unit allows the injection plunger 80 to be coupled to the transfer valve 82 melt and also to be uncoupled from the transfer valve 82 and moved in three dimensions (x, y, z coordinate planes) over the male core 88 of the mold 86.

A method of producing a thermoplastic composite by combining in-line compounding and EDCM using apparatus 70 will now be described. It is noted that in order for the twin screw extruder 74 to operate intermittently, the twin screw extruder 74 must be partially intermeshing and be powered by a hydraulic electric drive unit 91.

Polymer material (resin) 102 is preferably fed into the twin screw extruder 74 through inlet 92, using the gravimetric dosing unit 78. The resin 102 is melted within a first zone, generally shown at 106, of the twin screw extruder 74, forming a stream of plasticated resin (polymer melt) 202. Next, fiber material 104, preferably continuous fiber material drawn from creels (not shown), is fed into the side stuffer 76, and enters into the internal cavity 90 through the inlet 100. The fiber material 104 is mixed with the polymer melt 202 in a second zone, shown generally at 108, of the twin screw extruder 74 by the rotational operation of the twin screw extruder 74 to form a compounded melt within the second zone 108 of internal cavity 90.

The compounded melt flows through the outlet 96 of the twin screw extruder 74 and through the transfer valve 82 which is in the “open” position. The compounded melt is then extruded into the injection plunger 80. In this way, the transfer valve 82 controls the supply of polymer melt exiting the outlet 96 of the twin screw extruder 74 and extruded into the injection plunger 80.

Once the volume of compounded melt reaches a predetermined level in the injection plunger 80, rotation of the twin screw extruder 74 is stopped, and the transfer valve 82 closes. Once the transfer valve 82 is in the “closed” position, the injection plunger 80 undocks from the valve 82, and selectively deposits the compounded melt onto the male core 88 of the mold 86 through outlet die 204 in a precise and controlled fashion by operator command, or automatically, by computer or robotic command. The compounded melt deposited onto the male core 88 of the mold 86 is then compressed and cooled within the press 84 to form a component of the desired physical properties. After the component is cooled in the press 84, the press 84 is opened and the component demolded.

The positioning unit 72 provides the required mobile capability to the injection plunger 80 for movement in the x-y-z directions. Thus, injection plunger 80 has the enhanced flexibility to precisely place the compounded melt within or over the male core 88 of the mold 86.

After melt deposition is complete, the injection plunger 80 retracts from the press 84 and is recoupled with the valve 82. The valve 82 shifts to the “open” position to permit flow of compounded melt from the outlet 96 of the twin screw extruder 74 into the injection plunger 80. The rotational operation of the twin screw extruder 74 starts, and the compounded melt flows from the outlet 96 through the valve 82 to begin filling the injection plunger 80.

The end of the first process cycle, as described hereinabove, is coordinated with the beginning of the second process cycle. The feed of the resin 102 and fiber material 104 into the respective inlets 92, 100 of the twin screw extruder 74 is coordinated with the required output of compounded melt from the outlet 96 of the twin screw extruder 74.

If in-line compounding is not required for part production, apparatus 70 may be used for precompounded material processing. For precompounded material processing, precompounded polymer material is fed into the gravimetric dosing unit 78 of the twin screw extruder 74 for entry into the inlet 92 of the twin screw extruder 74.

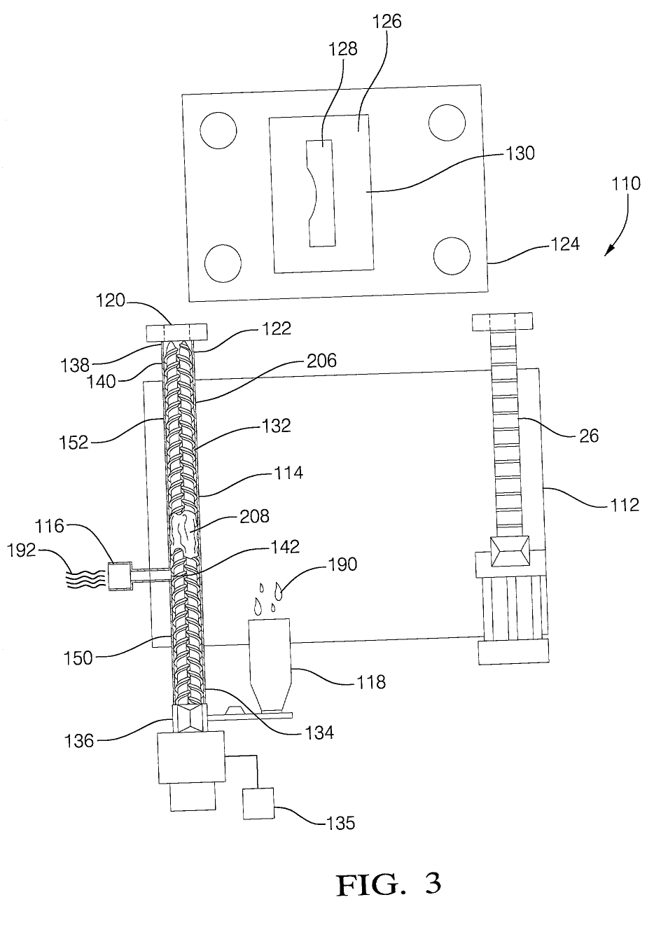

Referring to FIG. 3, an apparatus 10 for producing thermoplastic composites using in-line compounding and extrusion deposit compression molding (EDCM) according to a third embodiment of the present invention is shown. The twin screw extruder 114 is movably mounted upon the positioning unit 112 which allows the twin screw extruder 114 to be moved, in a preferred embodiment, in three dimensions (x, y, and z coordinate planes) over the male core 128 of the mold 126.

The apparatus 110 includes a positioning unit, preferably a three-axis table 112 and a solitary twin screw extruder, generally shown at 114, a side stuffer 116, a gravimetric dosing unit 118, a deposition die 120 and a press, preferably a vertical compression press 124. The press 124 contains a mold 126 having a female cavity (not shown) and a male core 128, each including a contact surface 130. The male core 128 is complimentary in shape with the female cavity and mates to the female cavity. The press 124 may be a conventional press generally used for molding polymers into desired shapes and forms.

The twin screw extruder 114 is designed to operate intermittently in a batch-type process and is a high-torque, high-output, twin screw extruder. By using a high-torque, high-output, twin screw extruder, an injection plunger is not required. Twin screw extruder 114 includes a body 206 having an internal cavity 132 disposed therein. The body 206 includes an inlet 134 at a first end 136, an outlet 138 at a second end 140, and an inlet 142 located along the length of the twin screw extruder 114 to accept fiber material 192 from the side stuffer 116. A deposition die 120 is mounted directly to the outlet 122 of the twin screw extruder 114. Deposition die 120 controls the supply of plastic melt exiting the outlet 138 of the twin screw extruder 114 and deposited onto the male core 128 of mold 126. Twin screw extruder 114 is mounted directly to the positioning unit 112 in order that the twin screw extruder 114 is permitted mobile movement to be moved in three dimensions (x, y, z coordinate planes) in a precise and controlled manner over the male core 128 of the mold 126.

A polymer material 190 is fed into the twin screw extruder 114 through inlet 134 by any number of feeding devices including, but not limited to, the use of the gravimetric dosing unit 118. Often, the polymer material 190 is in the form of plastic precompounded pellets. The polymer material 190 is melted within the twin screw extruder 114.

Fiber material 192 is fed from a fiber source (not shown) into the internal cavity 132 of the twin screw extruder 114 through a side stuffer 116 located along the length of the twin screw extruder 114. The fiber material 192 fed into the internal cavity 132 can be achieved by the side stuffer 116, as shown, or other similar feeding devices including, but not limited to, a direct roving feed roller (not shown). A direct roving feed roller may be used to feed at least one continuous strand of fiber into the internal cavity 132 of the twin screw extruder 114. Also, the fiber material 192 may be a single reinforcing fiber or a plurality of reinforcing fibers. The side stuffer 116 is in fluid communication with the internal cavity 132. The side stuffer 116 is utilized along the length of the twin screw extruder 114 for supplying chopped glass fibers or other low bulk density fillers into the internal cavity 132.

A method of producing a thermoplastic composite by combining in-line compounding and EDCM using apparatus 110 will now be described. It is noted that in order for the twin screw extruder 114 to operate intermittently, the twin screw extruder 114 must be partially intermeshing to provide a seal for pumping, and must be powered by a hydraulic electric drive unit 135.

Polymer material (pellets) 190 is fed into the twin screw extruder 114 through inlet 134 using the gravimetric dosing unit 118. The polymer material 190 is melted within a first zone, shown generally at 150, of the twin screw extruder 114, forming a plasticated resin (polymer melt) 208. Next, chopped fibers 192 from side stuffer 116, or alternatively continuous rovings, enter into the internal cavity 132 through the inlet 142. The fibers are mixed with the polymer melt 208 in a second zone, shown generally at 152, of the twin screw extruder 114 by the rotational operation of the twin screw extruder 114 to form a reinforced melt compound within the second zone 152 of the internal cavity 132.

Once the volume of compounded melt (extrudate) within the twin screw extruder 114 reaches a predetermined quantity, rotation of the twin screw extruder 114 is stopped. The twin screw extruder 114 mounted to the positioning unit is positioned over the mold 126. When desired, by operator command, or automatically, by computer or robotic command, the twin screw extruder 114 selectively deposits the compounded melt through an opening 122 in the deposition die 120 onto the male core 128 of the mold 126 in a precise and controlled fashion.

The control of the supply of polymer melt exiting the deposition die 120 of the twin screw extruder 114 and deposited onto the male core 128 of compression mold 126 is as follows. In one embodiment of the present invention, according to FIG. 3, the twin screw extruder 114 rotates to advance the compounded melt into and through the deposition die 120. Rotation of the twin screw extruder 114 begins after the twin screw is positioned such that the deposition die 120 is located directly over the male core 128 of the mold 126. Rotation of the twin screw extruder 114 stops at the end of melt deposition.

Another embodiment, according to the present invention, may include a reciprocating screw (not shown) which rotates within the body 206 to extrude the polymer melt towards the deposition die 120, the reciprocating screw simultaneously moving in a direction away from the second end 140 to form a volume of plastic shot proximate to the deposition die 120. The reciprocating screw then moves toward the second end 140, plunging the plastic shot of compounded melt through the deposition die 120. The volume of melt is accumulated in front of the twin screw extruder during rotation and extruded through the deposition die, using the reciprocating motion of the reciprocating twin screw extruder.

The compounded melt deposited onto the male core 128 is then compressed and cooled within the mold 126 to form a component with the desired physical properties. After the component is cooled in the mold 126, the press 124 is opened, and the component demolded.

After melt deposition is complete and the component is demolded, the second batch of compounded melt is then ready to be extruded onto the male core 128 of the mold 126.

The end of the first process cycle, as described hereinabove, is coordinated with the beginning of the second process cycle. The feed of the polymer material 190 and fiber material 192 into the respective inlets 134, 142 of the twin screw extruder 114 is coordinated with the required output of compounded melt from deposition die 120 of the twin screw extruder 114.

If in-line compounding is not required for part production, twin screw extruder 114 of apparatus 110 may be used for precompounded material processing. For precompounded material processing, precompounded polymer material is fed into the gravimetric dosing unit 118 of the twin screw extruder 114 for entry into the inlet 134 of the twin screw extruder 114.

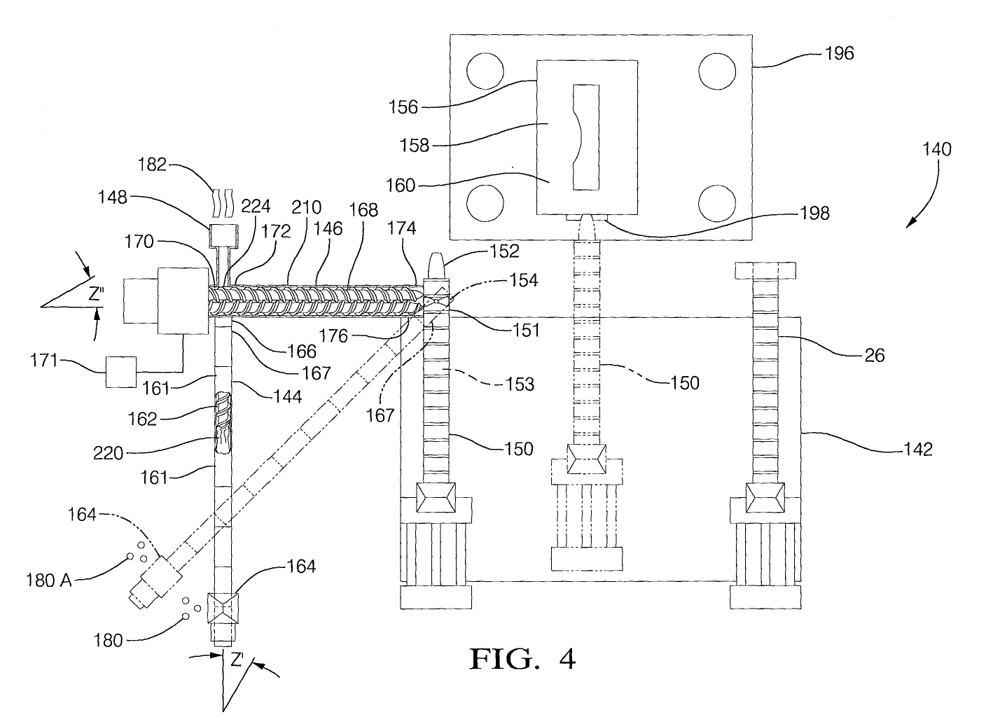

Referring to FIG. 4, an apparatus 140 for producing thermoplastic composites using in-line compounding and injection molding is shown, according to an alternative embodiment of the present invention.

The apparatus 140 includes a positioning unit, preferably a three-axis positioning unit 142 and a single screw extruder, generally shown at 144, a twin screw extruder, generally shown at 146, a side stuffer 148, injection plunger 150, an injection nozzle 152, a transfer valve 154 and an injection mold 156. The injection mold 156 includes a female cavity (not shown) and a male core 158, each including a contact surface 160. The male core 158 is complimentary in shape with the female cavity and mates to the female cavity. The injection mold 156 may be a conventional injection mold as is generally used for molding polymers into desired shapes and forms. The male core 158 and the female cavity of the mold 156 are disposed such as to create a space therebetween for receiving the melted polymers injected.

The single screw extruder 144 and the twin screw extruder 146 are designed to operate intermittently in a batch-type process. Single screw extruder 144 contains a plurality of barrel segments 161 within an internal cavity 162, an inlet 164, and a transfer die 166 located at an outlet 167. Twin screw extruder 146 includes a body 210 having an internal cavity 168 disposed therein. The body 210 includes an internal cavity 168 having an inlet 170 at a first end 172, an outlet 174 at a second end 176, and an inlet 224 located along the length of the twin screw extruder 146 to accept fiber material 182 from the side stuffer 148, or alternatively, continuous fiber rovings from a roving creel rack (not shown). The transfer valve 154 is connected to the outlet 174 of twin screw extruder 146. In this way, the transfer valve 154 controls the flow melt from the twin screw extruder 146 into the injection plunger 150.

A polymer material (resin) 180 is fed into the internal cavity 162 of the single screw extruder 144 by any number of feeding devices including, but not limited to, the use of a hopper (not shown). Often, the polymer material 180 is in the form of plastic pellets. The polymer material 180 is melted within the single screw extruder 144.

Fiber material 182 is fed from a fiber source (not shown) into the internal cavity 168 of the twin screw extruder 146 through a side stuffer 148 located along the length of the twin screw extruder 146. The fiber material 182, fed into the internal cavity 168, can be achieved by the side stuffer 148, as shown, or other similar feeding devices, including, but not limited to, a direct roving feed roller (not shown). A direct roving feed roller may be used to feed at least one continuous strand of fiber into the internal cavity 168 of the twin screw extruder 146. Also, the fiber material 182 may be a single reinforcing fiber or a plurality of reinforcing fibers. The side stuffer 148 is in fluid communication with the internal cavity 168. The side stuffer is utilized along the length of the twin screw extruder 146 for supplying chopped glass fibers or other low bulk density fibers into the internal cavity 168.

The outlet 174 of the twin screw extruder 146 is coupled with transfer valve 154. The injection plunger 150 releasably docks or couples with the transfer valve 154. The injection plunger 150 includes an inlet 151, and an internal cavity 153, and is movably mounted on the positioning unit 142. The positioning unit 142 allows the injection plunger 150 to be coupled to the transfer valve 154 and also to be uncoupled from the transfer valve 154, and moved in three dimensions (x, y, z coordinate planes) over the male core 158 of the mold 156.

A method of producing a thermoplastic composite by combining in-line compounding and injection molding employing apparatus 140 will now be described. It is noted that in order for the twin screw extruder 146 to operate intermittently, the twin screw extruder 146 must be partially intermeshing and be powered by a hydraulic electric drive unit 171.

Resin 180 is fed into the single screw extruder 144 through inlet 164 using the hopper (not shown). The resin 180 is melted within the plurality of barrel segments 161, forming a stream of plasticated resin (polymer melt) 220. Upon exiting the transfer die 166, the plasticated resin 220 drops vertically downward into an inlet 224 of the twin screw extruder 146. Simultaneously with the operation of the single screw extruder 146, chopped fibers 182 from the side stuffer 148, or alternatively continuous fiber rovings, enter into the internal cavity 168 through the inlet 170 of the twin screw extruder 146. The fiber material 182 is mixed with the plasticated resin 220 by the rotational operation of the twin screw extruder 146 to form a compounded melt within the internal cavity 168.

The compounded melt flows through the twin screw extruder 146 and through the transfer valve 154 in the “open” position, and is extruded into the injection plunger 150. In this way, the transfer valve 154 controls the supply of polymer melt exiting the outlet 174 of the twin screw extruder 146 and extruded into the injection plunger 150.

Once the injection plunger 150 contains a predetermined volume of compounded melt, rotation of the single and twin screw extruders 144, 146 are stopped, and the transfer valve 154 closes. Once the transfer valve 154 is in the “closed” position, the injection plunger 150 (shown in phantom) is uncoupled from the valve 154 and is moved in order that the injection nozzle 152 is positioned to be docked to bushing 198, to inject the compounded melt into the closed cavity of the injection mold 156. Once the nozzle 152 is docked to the bushing 198, the polymer melt is forced from the injection plunger 150 into injection mold 156. Alternatively, it is noted that the injection mold 156 may be open during injection and closed after injection, or the mold may be open during injection and closed during injection.

Once injected, the polymer melt is cooled to a predetermined temperature at a predetermined pressure. Prior to demolding, the injection mold 156 is then opened to expose the injection molded component.

The positioning unit 142 provides the required capability to maneuver the injection plunger 150 in the x-y-z directions, thus permitting enhanced flexibility of the placement of the compounded melt within the mold 156.

After injection is complete, the injection plunger 150 undocks from the bushing 198 and is recoupled with the valve 154. The valve 154 shifts to the “open” position to permit flow of compounded melt from the outlet 174 of the twin screw extruder 146 into the injection plunger 150. The rotational operation of the single screw extruder 144 and the twin screw extruder 146 start, and the compounded melt flows from the outlet 174 of the twin screw extruder 146 through the valve 154 to begin filling the injection plunger 150. Filling of the injection plunger 150 occurs during the cooling phase of the previous molding cycle.

The feed of the polymer material 180 and fiber material 182 into the respective inlets 170, 224 of the single and twin screw extruders 164, 170 is coordinated with the required output of compounded melt from outlet 174 of the twin screw extruder 146. The output of the single screw extruder 144 is controlled by the rpm of the single screw extruder 144.

If in-line compounding is not required for part production, apparatus 140 may be used for precompounded material processing. For precompounded material processing, the twin screw extruder 146 is removed. The transfer die 166 is removed from the single screw extruder 144 (shown in phantom) and the transfer valve 154 is connected to the outlet 167 of the single screw extruder 144. The single screw extruder 144 directly feeds the compounded melt to injection plunger 150 through the transfer valve 154.

The method of using apparatus 10 with precompounded material will now be described where like reference numbers refer to like parts.

A precompounded polymer material 180A is fed into the single screw extruder 144 (shown in phantom) through inlet 164 by any number of feeding devices including, but not limited to, the use of a hopper (not shown). Often, the precompounded polymer material 180A is in the form of plastic pellets. The precompounded polymer material 180A is melted within the plurality of barrel segments 161 forming a polymer melt 220. Upon exiting the outlet 167, the polymer melt 220 is fed into the injection plunger 150 via the transfer valve 154. In this way, the transfer valve 154 controls the supply of polymer melt 220 exiting the outlet 167 of the single screw extruder 144 and deposited into the injection plunger 150.

Once the volume of polymer melt 220 reaches a predetermined level in the injection plunger 150, rotation of the single screw extruder 144 is stopped and the valve 154 closes. Once the transfer valve 154 is in the “closed” position, the injection plunger 150 is uncoupled from the valve 154 and is moved for docking with a bushing 198. Once the nozzle 152 is docked to the bushing 198, the precompounded polymer melt is forced from the injection plunger 150 into injection mold 156, which is preferably closed. Alternatively, the injection mold 156 may be open during injection and closed after injection, or the mold may be open during injection and closed during injection.

Once injected, the precompounded polymer melt is cooled to a predetermined temperature at a predetermined pressure. Prior to demolding, the injection mold 156 is then opened to expose the injection molded component.

The positioning unit 142 provides the required capability to maneuver the injection plunger 150 in the x-y-z directions, thus permitting precise location of the injection nozzle 152 to the bushing 198 prior to injection.

The end of the first process cycle, as described hereinabove, is coordinated with the beginning of the second process cycle. The second batch of compounded melt is then ready to be formed. After injection is complete, the injection plunger 150 undocks from the bushing 198 and is recoupled with the valve 154. The valve 154 shifts to the “open” position to permit flow of precompounded polymer melt from the outlet 167 of the single screw extruder 144 into the injection plunger 150. The rotational operation of the single screw extruder 144 starts, and the precompounded polymer melt flows from the outlet 167 of the single screw extruder 144 through the valve 154 to begin filling the injection plunger 150. The feed of the resin 180A into the inlet 164 of the single extruder 144 is coordinated with the required output of compounded melt from the outlet 167 of the single screw extruder 144.

For the fourth embodiment shown in FIG. 4 for in-line compounding and injection molding, the single screw extruder 144 and the twin screw extruder 146 are shown positioned generally perpendicular to each other. In this configuration, as illustrated in FIG. 4, short screw (not shown) is installed within the internal cavity 162 of the single screw extruder 144. It is understood by those skilled in the art that alternatively, the single screw extruder 12 may be moved rearward as opposed to removing the barrel or screw segments in order to shorten the existing configuration. Further, the position between the single screw extruder 12 and the twin screw extruder 14 may vary depending on floor space constraints. For example, the single screw extruder 12 may be rotated an angle z′ degrees about the z axis and the twin screw extruder 14 may be rotated an angle z′ degrees about the z axis in order to avoid barrel and screw segment removal within the single screw extruder 12. It may also be desirable to position the single and twin screw extruders 12, 14, respectively, such that the single screw extruder 12 is in line with the twin screw extruder 14 in order to save available floor space on which to mount apparatus 10.

Referring to FIG. 1, it is noted, within the scope of this invention, that apparatus 10 may be utilized in conjunction with a conventional injection unit 26 as shown in FIG. 1. After the injection plunger 18 deposits the compounded melt into the mold 32 as described hereinabove with reference to FIG. 1, injection plunger 26 may be utilized to deposit a low cost polymer material (e.g. non fiber-filled material) into the mold 32. The injection plunger 26 may be used simultaneously or sequentially with injection plunger 18. Thus, advantageously, apparatus 10 permits an existing injection plunger 26 to be utilized with injection plunger 18 in order to produce a fiber-reinforced structural component with varying physical properties (e.g. stiffness, energy absorption) using fiber-filled material only in areas of the component where increased mechanical properties are required while using an unfilled commodity grade material in the remaining areas.

It is further noted that apparatus 70, 110 and 140 may also advantageously and similarly be used with existing injection unit 26 as shown in FIGS. 2, 3 and 4, respectively.

Referring to FIGS. 1 and 4, the apparatus 10, 140 uses one single screw extruder 12, 144 and one twin screw extruder 14, 146 operating in intermittent batch mode for in-line compounding and EDCM/injection molding, thereby eliminating the need for a compounded melt accumulating device to transfer compounded melt from the single and twin screw extruders 12, 14, 144, 146 to the press 28, 196.

The method and apparatus 10 also provide the ability to selectively extrusion deposit in-line compounded materials and precompounded materials (e.g. filled and unfilled) for placement within the same mold cavity in order to produce an engineered component that meets the specific part performance requirements. This is achieved by using a positioning table 24 on which to movably mount the injection plunger 18, such that the injection plunger 18 may be maneuvered over the male core 62 of the open compression mold 28 in three dimensions, commonly understood to be the x, y, and z coordinate planes. The ambulatory nature of the injection plunger 18 allows disposition of the fiber-reinforced polymer compound in various concentrations and arrangements over the male core 62 of the mold 28. Thus, the amount and distribution of fiber reinforcement may be varied within the cavity of the mold 28, resulting in a polymer structural component having enhanced reinforcement where desired. This ambulatory feature also applies to injection plunger 150 shown in FIG. 4.

Furthermore, apparatus 10 provides the ability to feed the injection plunger 18 from the twin screw extruder 14 or the single screw extruder 12 for enhanced molding flexibility. This advantage allows the composite structural component produced to be tailored to meet specific performance requirements by adjusting fiber or filler type, and fiber or filler content by weight.

Apparatus 10 also facilitates the processing of heat sensitive materials (e.g. natural fibers). Prolonged heat exposure that degrades the properties of heat sensitive materials is reduced since the fibers are added into the twin screw extruder 14 only, as opposed to being fed in a precompounded form to the single screw extruder 12 for future processing. This benefit permits the use of a greater selection of heat sensitive additives such as modifiers and colorants.

Referring to FIGS. 1, 2, 3, and 4, all of the advantages and benefits of the apparatus 10 and method of the first embodiment described hereinabove for providing the flexibility to in-line compound glass, natural fiber, or other fillers and additives and locate the melt compound precisely onto an open mold thereby reducing capital equipment modifications, reducing capital equipment cost and eliminating material transfer devices apply equally to the second, third and fourth embodiment as shown in FIGS. 2, 3 and 4. Further, apparatus 10, 70, 110, 140 provide for in-line compounding minimizing the higher material costs associated with procuring precompounded materials. Apparatus 140 provides for in-line compounding with injection molding to eliminate the necessity of secondary finishing operations on the component once it is demolded.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

1. An apparatus for providing a reinforced structure, the apparatus comprising:
a first extruder being configured to receive a first meltable material, the first extruder melts the first meltable material to form a melt compound;
a plunger being configured to receive the melt compound from the first extruder; and
a mold for receiving the melt compound and producing the reinforced structure, wherein the melt compound is intermittently released through the plunger.

2. The apparatus of claim 1, wherein the first extruder includes a first inlet, an outlet and an internal cavity formed therein, the first inlet configured to receive the first meltable material, and the plunger having an inlet, an outlet die and an internal cavity, the inlet of the plunger coupled to the outlet of the first extruder for receiving the melt compound and the melt compound is intermittently released through the outlet die of the plunger for deposit into the mold.

3. The apparatus of claim 2, wherein the first extruder includes a second inlet to receive a second meltable material.

4. The apparatus of claim 3, further comprising:
a second extruder having a first inlet, an outlet die, and an internal cavity formed therein, the first inlet of the second extruder configured to receive the first meltable material, and the outlet die of the second extruder in fluid communication with the second inlet of the first extruder, the second extruder plasticates the first meltable material, and the first meltable material mixes with the second meltable material in the first extruder to form the melt compound.

5. The apparatus according to claim 1, further comprising:
a positioning unit, wherein the plunger is movably mounted to the positioning unit for positioning of the outlet die of the plunger over the mold.

6. The apparatus of claim 1, wherein the mold is a compression mold.

7. The apparatus according to claim 5, wherein the positioning unit is a 3-axis table for movement of the plunger in the x, y, z coordinate planes.

8. The apparatus according to claim 2, further comprising:
a valve coupled between the inlet of the plunger and the outlet of the first extruder, the valve being in fluid communication with the internal cavity of the plunger and the internal cavity of the first extruder, the valve opens to release the melt compound to flow from the outlet of the first extruder to the inlet of the plunger and closes when the plunger fills to a predetermined volume.

9. The apparatus of claim 1, wherein the first extruder is a solitary twin screw extruder.

10. The apparatus of claim 3, wherein the second meltable material is at least one reinforcing fiber element.

11. The apparatus of claim 1, wherein the melt compound comprises a thermoplastic material.

12. The apparatus of claim 1, the first meltable material is precompounded resin pellets and the first extruder is a solitary single screw extruder.

13. The apparatus of claim 9, wherein the second extruder is a solitary single screw extruder.

14. The apparatus according to claim 1, wherein the first meltable material is made of resin

15. The apparatus of claim 10, wherein the at least one reinforcing fiber element comprises a fiber bundle forming a plurality of reinforcing fibers.

16. The apparatus according to claim 15, wherein the first extruder is a high output, high torque twin screw extruder.

17. An apparatus for providing a reinforced structure, comprising:
a first extruder, having a first inlet, an outlet and an internal cavity formed therein, the first inlet configured to receive a first meltable material, the first extruder melts the first meltable material;
at least one fiber source for feeding at least one reinforcing fiber element into the internal cavity of the first extruder for compounding with the first meltable material to form a melt compound, the internal cavity configured to mix the at least one fiber source and the first meltable material to form a melt compound;
a plunger having an inlet, an outlet and internal cavity for receiving the melt compound, the inlet of the plunger coupled to the outlet of the first extruder; and
a mold for receiving the melt compound and producing the reinforced structure, the melt compound is intermittently released through the outlet of the plunger for injection into the mold.

18. The apparatus of claim 17, wherein the mold is an injection mold.

19. The apparatus of claim 17, wherein the injection plunger includes a nozzle at an end thereof for insertion into the injection mold.

20. The apparatus of claim 17, further including:
at least one fiber source for feeding at least one reinforcing fiber element into the internal cavity of the first extruder for compounding with the first meltable material to form a melt compound, the inlet of the plunger for receiving the melt compound and the mold for receiving the melt stream, the melt compound is intermittently released through the outlet die of the injection plunger for deposit onto the mold and producing a fiber-reinforced molded structural component

21. A method for forming a reinforced structure, comprising:
feeding a first meltable material into a first extruder;
melting the first meltable material in the first extruder forming a melt;
extruding the melt from the first extruder;
compounding the melt with a fiber material in the first extruder;
continually depositing the melt into an injection plunger;
intermittently stopping the first extruder in a batch process;
depositing the melt from the injection plunger into a molding device; and
forming a first section of the reinforced structure within the molding device.

22. The method of claim 21, wherein feeding the melt into the first extruder includes:
providing a second meltable material to a second inlet formed in the first extruder; and
heating the second meltable material forming the melt in the first extruder.

23. The method of claim 21, wherein feeding the melt into the first extruder includes:
providing a second meltable material to a first inlet in a second extruder;
heating the second meltable material forming the melt in the second extruder; and
transferring the melt from the second extruder to the first extruder.

24. The method of claim 23, additionally including:
stopping intermittently the second extruder during the batch process.

25. The method of claim 21, wherein the first extruder is a solitary twin screw extruder.

26. The method of claim 21, wherein the fiber material is at least one fiber element.

27. The method of claim 23, wherein the second extruder is a solitary single screw extruder

28. The method of claim 23, wherein the depositing step of the melt comprises:
controlling the flow of the melt from the first extruder to the injection plunger with a valve.

29. The method of claim 21, further comprising:
restarting the first extruder;
feeding a second melt into the first extruder;
feeding a third material to the first inlet of the first extruder;
extruding the second melt within the first extruder;
compounding the second melt with a fiber element in the first extruder;
continually depositing the second melt into the injection plunger;
stopping intermittently the first extruder in a batch process;
depositing the second melt from the injection plunger into the molding device; and
forming a second section of the reinforced structure within the molding device.

30. A method for forming a reinforced structure using extrusion deposit compression molding in a batch process, comprising:
providing a first extruder;
feeding a first meltable material to a first inlet in the first extruder;
heating the first meltable material forming a melt of first meltable material;
extruding the melt within the first extruder;
continually depositing the melt to an injection plunger;
stopping intermittently the first extruder during the batch process;
depositing the melt from the injection plunger into a molding device; and
forming the reinforced structure within the molding device.

31. The method of claim 30 wherein the first meltable material is precompounded resin pellets.
